(19) United States
(12) Patent Application Publication
(10) Pub. No.: US 2011/0228051 A1
(43) Pub. Date: Sep. 22, 2011

(54) Stereoscopic Viewing Comfort Through Gaze Estimation

(76) Inventors: Goksel Dedeoglu, Plano, TX (US); Aziz Umit Batur, Dallas, TX (US)

(21) Appl. No.: 13/049,714

(22) Filed: Mar. 16, 2011

Related U.S. Application Data
(60) Provisional application No. 61/314,618, filed on Mar. 17, 2010.

(51) Int. Cl. H04N 13/02; H04N 13/04

(52) U.S. Cl. 348/46; 348/51; 348/E13.074; 348/E13.075

(57) ABSTRACT

A method of improving stereo video viewing comfort is provided that includes capturing a video sequence of eyes of an observer viewing a stereo video sequence on a stereoscopic display, estimating gaze direction of the eyes from the video sequence, and manipulating stereo images in the stereo video sequence based on the estimated gaze direction, whereby viewing comfort of the observer is improved.

### CROSS-REFERENCE TO RELATED APPLICATIONS

This application claims benefit of U.S. Provisional Patent Application Ser. No. 61/314,618, filed Mar. 17, 2010, which is incorporated by reference herein in its entirety.

### BACKGROUND OF THE INVENTION

Light reflected from an object generates a light field in space. Each eye of a person looking at that object will capture the light field differently due to its positioning relative to the object, and the person's brain will process the two differing perceptions of the light field to generate the three dimensional (3D) perception.

Stereoscopic imaging may be used to simulate 3-D images for viewers. Stereoscopic displays provide different yet corresponding perspective images of an object or scene to the left and right eye of the viewer. The viewer's brain processes the two images to create a 3D perception of the object or scene. In general, stereoscopic systems rely on various techniques to generate the perspective images for the right and left eye. In addition, stereoscopic imaging systems may use parallax barrier screens such as headgear or eye wear to ensure that the left eye sees only the left eye perspective and the right eye sees only the right eye perspective.

There are aspects of the human visual system that stereo cameras used to capture the images cannot replicate, requiring human observers to adapt to those aspects that cannot be replicated. When a human observer cannot adapt, the stereo viewing experience may be uncomfortable, e.g., may cause eye-strain, headache, etc.

### BRIEF DESCRIPTION OF THE DRAWINGS

Particular embodiments in accordance with the invention will now be described, by way of example only, and with reference to the accompanying drawings:

FIGS. 1A-1C illustrate human eye convergence and stereo camera convergence;

FIGS. 2, 3, and 5 show block diagrams of stereoscopic display systems in accordance with one or more embodiments of the invention;

FIG. 4 illustrates on-screen parallax in accordance with one or more embodiments of the invention; and

FIGS. 6-10 show flow diagrams of methods in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail and/or shown to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

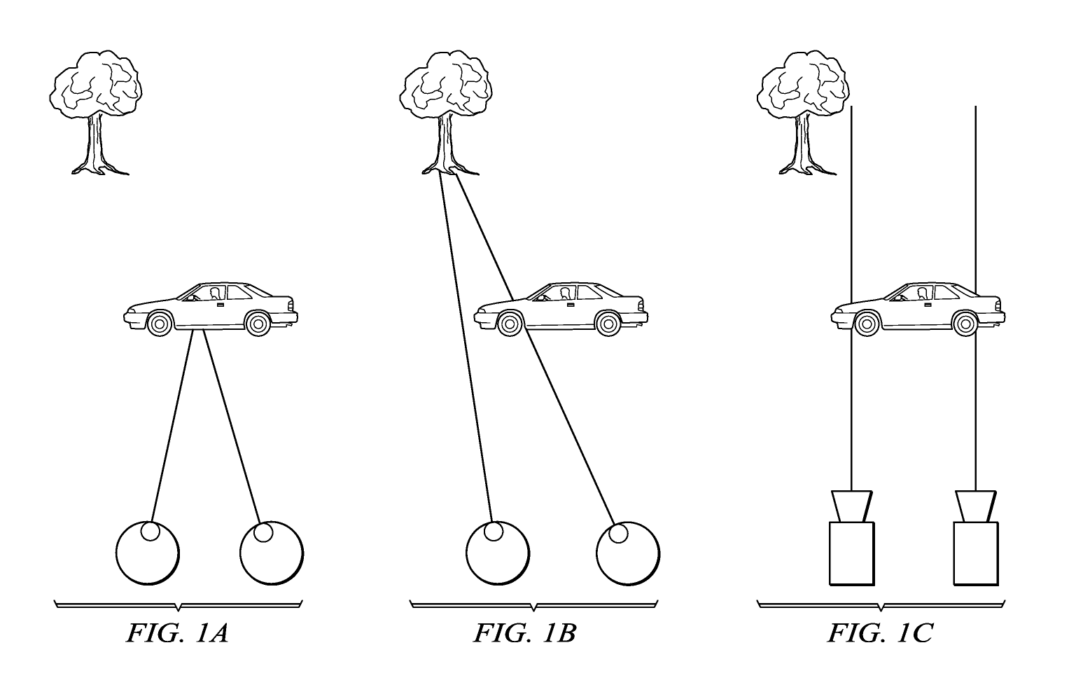

As previously mentioned, there are some aspects of the human visual system that current stereo cameras do not replicate. One such aspect is that when viewing a scene, humans naturally converge their eyes on objects of interest at various distances. This is illustrated in FIGS. 1A and 1B. In the scene of these two figures, there are two objects of interest at different distances, a car and a tree. FIG. 1A illustrates the natural convergence on the closer object and FIG. 1B illustrates the natural convergence on the more distant object. Neither the particular order and position of these convergence points, nor their duration can be known ahead of time. In contrast, in a stereo camera configuration used to capture the perspective images for display on a stereoscopic display, the orientation of the left-right camera pair may be fixed. This is illustrated in FIG. 1C, where the stereo camera pair has a fixed convergence at infinity. This discrepancy represents a challenge for stereoscopic displays, in that such displays require the human observer to adapt to the fixed convergence setting of the stereo camera that captured the displayed images.

Embodiments of the invention address the human eye convergence issue in the context of stereoscopic displays. More specifically, in embodiments of the invention, a stereoscopic display system includes a video capture device, e.g., a camera, that continuously captures video of the observer's eyes as the observer is watching a stereo video on a stereoscopic display. The video of the eyes is processed in real-time to estimate the observer's gaze direction in the stereo video being displayed on the stereoscopic display. The estimated gaze direction is then used to manipulate the stereo images on the fly to improve the viewing comfort of the observer. This manipulation technique may vary depending on the type of 3D content that the observer is watching.

More specifically, in different embodiments of the invention, different techniques for adjusting the horizontal shift, also referred to as stereo separation, between the left and right images based on the estimated gaze direction may be used when the 3D content is captured using fixed stereo cameras or is generated with virtual fixed stereo cameras. Further, when flexible stereo cameras are used to generate the 3D content, e.g., where the 3D content is generated from a computer graphics model such as in 3D computer games, the estimated gaze direction may be used to adjust the locations of the cameras so that they match the observer's eyes in terms of orientation in 3D space. Embodiments of the invention are potentially fully adjustable to any human. Further, embodiments of the invention enable fully automatic solutions that understand where an observer is looking, and do so adaptively.

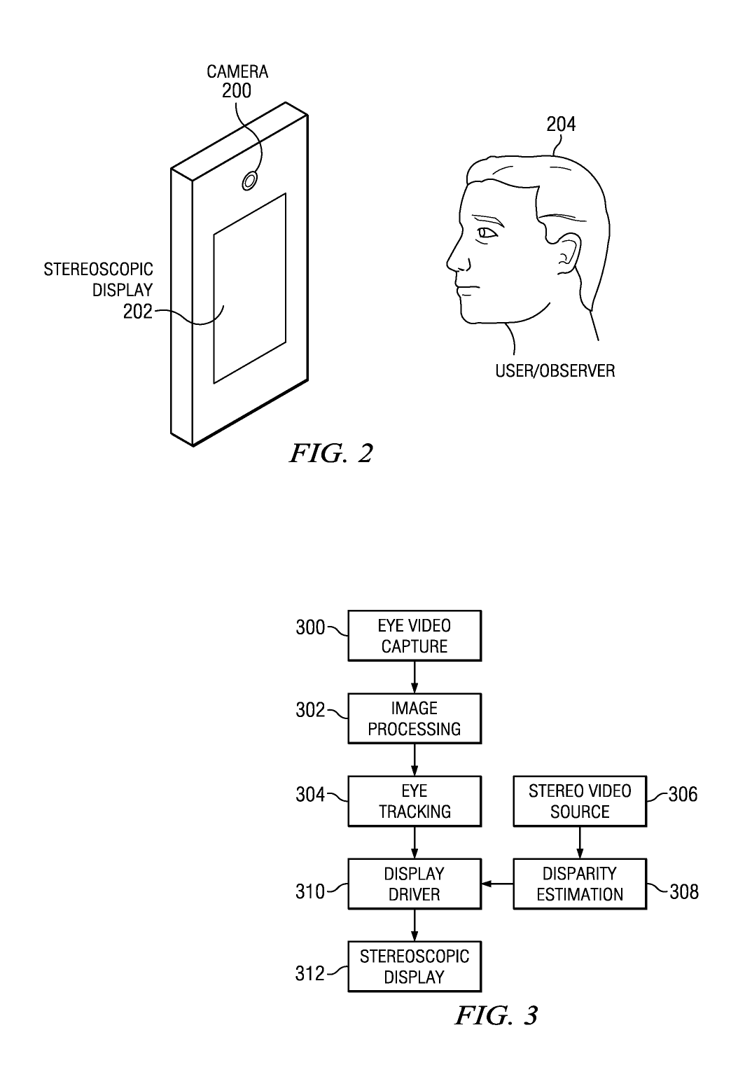

FIG. 2 shows a block diagram of stereoscopic display system in accordance with one or more embodiments of the invention. A camera (200) is positioned to continuously capture the eyes of a user/observer (204) in a video sequence while 3D content is displayed on the stereoscopic display (202). As is explained in more detail herein, the video sequence is analyzed to estimate the gaze direction of the user/observer's eyes as the user/observer (204) views 3D content shown on the stereoscopic display (202). The estimated gaze direction is then used to manipulate, i.e., adjust, stereo images in the 3D content to improve the viewing experience of the user/observer (204). As is explained in more detail herein, the particular adjustments made depend on whether the stereo cameras used to capture/generate the 3D content are fixed or flexible.

The stereoscopic display system of FIG. 2 illustrates a camera (200) and a stereoscopic display (202) embodied in a single system. The single system may be, for example, a handheld display device specifically designed for use by a single user in viewing 3D content, a display system attached to a desktop computer, laptop computer, or other computing device, a cellular telephone, a handheld video gaming device, a tablet computing device, wearable 3D glasses, etc. In other embodiments of the invention, the camera and the stereoscopic display may be embodied separately. For example, a separate camera may be suitably positioned near or on top of a stereoscopic display screen to capture the video sequence of the user/observer's eyes. In another example, one or more cameras may be placed in goggles or other headgear worn by the user/observer to capture the video sequence(s) of the eyes. Depending on the processing capability of the headgear, the video sequence(s) or eye convergence data may be transmitted to a system controlling the stereoscopic display.

FIG. 3 is a block diagram of a stereoscopic display system in accordance with one or more embodiments of the invention. The stereoscopic display system includes an eye video capture component (300), an image processing component (302), an eye tracking component (304), a stereo video source (306), a disparity estimation component (308), a display driver component (310), and a stereoscopic display (312).

The eye video capture component (300) is positioned to capture optical images of an observer's eyes. The eye video capture component (300) may be, for example, a CMOS sensor, a CCD sensor, etc., that converts optical images to analog signals. These analog signals may then be converted to digital signals and provided to the image processing component (302).

The image processing component (302) divides the incoming digital signal into frames of pixels and processes each frame to enhance the image in the frame. The processing performed may include one or more image enhancement techniques. For example, the image processing component (302) may perform one or more of black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment. The processed frames are provided to the eye tracking component (304). In some embodiments of the invention, the eye video capture component (300) and the image processing component (302) may be a digital video camera.

The eye tracking component (304) includes functionality to analyze the frames of the video sequence in real-time, i.e., as a stereo video is displayed on the stereoscopic display (312), to detect the observer's eyes, track their movement, and estimate the gaze direction, also referred to as point of regard (PoR) or point of gaze (POG). Any suitable techniques with sufficient accuracy may be used to implement the eye detection, tracking, and gaze estimation. Some suitable techniques are described in D. W. Hansen and Q. Ji, “In the Eye of the Beholder: A Survey of Models for Eyes and Gaze”, IEEE Transactions on Pattern Analysis and Machine Intelligence, Vol. 32, No. 3, 2010. The gaze direction estimation, i.e., an indication of the area on the stereoscopic display (312) where the observer's gaze is directed, is provided to the display driver component (310). In some embodiments of the invention, the eye tracking component (304) may provide a gaze direction estimate for each eye to the display driver component (310). In some embodiments of the invention, the gaze direction estimation includes pixel coordinates of the area where the observer's gaze is directed.

The stereo video source (306) provides a stereo video sequence for display on the stereoscopic display (312) via the display driver component (310). The stereo video source (306) may be a pre-recorded stereo video sequence, a graphics system that generates a stereo video sequence in real-time, a stereo camera system (fixed or flexible) that captures a stereo video sequence in real-time, a computer-generated hybrid synthesis of 2D images and 3D depth information, etc. The hybrid synthesis may be generated, for example, by applying a 2D-to-3D conversion algorithm to a 2D video sequence to generate a 3D stereo video sequence. In another example, a 3D depth sensor may be applied to 2D images to synthesize 3D. Each 2D image may be considered to be the left image and the application of the 3D depth sensor would synthesize a right image from the 2D image to create a left-right stereo image pair.

The disparity estimation component (308) includes functionality to estimate the disparity between a left image and a corresponding right image in the stereo video sequence. Any suitable technique for disparity estimation may be used, such as, for example, one of the techniques described in D. Scharstein and R. Szeliski. “A Taxonomy and Evaluation of Dense Two-Frame Stereo Correspondence Algorithms”, International Journal of Computer Vision, 47(1/2/3):7-42, 2002. Disparity in this context may be defined as the difference in horizontal location of corresponding features seen by the left and right eyes. In some embodiments of the invention, the disparity between all pixels in the left image and corresponding pixels in the right image is estimated, and the result is a disparity image with a disparity value for each pixel pair.

In other embodiments of the invention, the disparity estimation is performed for pixels in a region of interest (ROI) in the left and right images, and the result is a disparity ROI with a disparity value for each pixel pair in the ROI. The region of interest (ROI) may be defined as a region of pixels in the two images corresponding to the gaze estimation computed by the eye tracking component (304). That is, the indication of the area on the stereoscopic display where the observer's gaze is directed may be used to determine a corresponding area of pixels in the two images. This area of pixels may be used as the ROI or a larger number of pixels surrounding the area of pixels may be used.

The display driver component (310) includes functionality to control the operation of the stereoscopic display (312). In one or more embodiments of the invention, the display driver component (310) automatically adjusts the stereo separation (horizontal shift) between the right and left images in a stereo video sequence based on the gaze direction estimation and the disparity estimation while the stereo video sequence is being displayed on the stereoscopic display (312). Stereo separation or horizontal shift is an adjustable parameter in stereoscopic displays: it refers to a global horizontal shift operation between the right and left images before they are shown to the observer.

In some such embodiments, the display driver component (310) determines a representative disparity value and uses that value to adjust the horizontal shift such that there is no disparity where the observer's gaze is directed as indicated by the gaze direction estimation from the eye tracking component (304). In some embodiments of the invention, the adjustment is made by setting a horizontal shift parameter to the negative of the representative disparity value. In embodiments of the invention where the disparity estimation component (308) generates a disparity image, the representative disparity value is determined from an ROI in the disparity image.

The ROI may be defined as a region of pixels in the disparity image corresponding to the gaze direction estimation computed by the eye tracking component (304). That is, the indication of the area on the stereoscopic display where the observer's gaze is directed may be used to determine a corresponding area of pixels in the disparity image. This area of pixels may be used as the ROI or a larger number of pixels surrounding the area of pixels may be used. In embodiments of the invention where the disparity estimation component (308) generates a disparity ROI, the representative disparity value is determined from the disparity ROI. Any suitable technique may be used to determine the representative disparity value, such as, for example, computing an average disparity value or a median disparity value in the ROI.

In one or more such embodiments, the display driver component (310) determines a representative disparity value as previously described and the on-screen parallax, and uses both to gradually adjust the horizontal shift until there is no disparity where the observer's gaze is directed as indicated by the gaze direction estimation from the eye tracking component (304). On-screen parallax may be defined as the disparity that the 3D convergence point of the observer's eyes would have when projected onto the stereoscopic display (312).

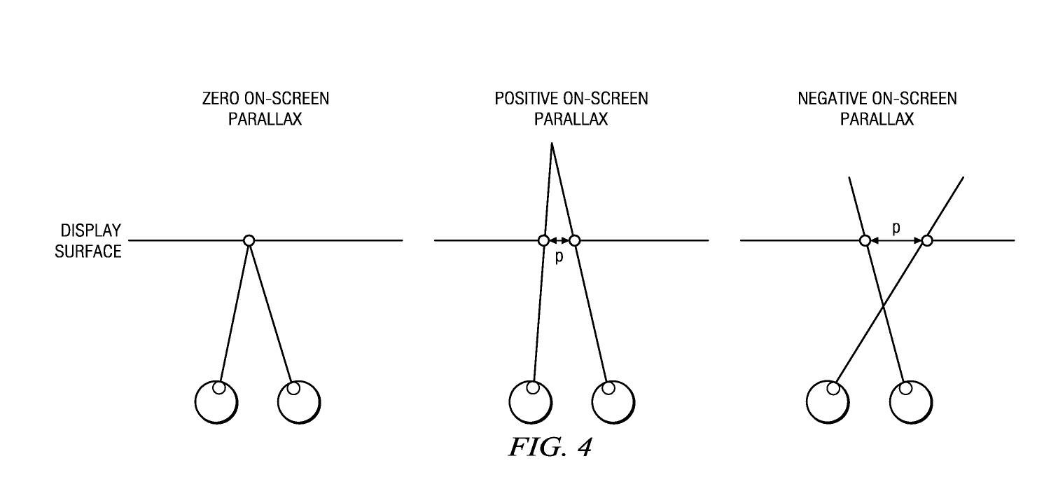

Referring now to FIGS. 3 and 4, using the geometry shown, the display driver component (310) calculates how the left and right “gaze rays” intersect the display surface, i.e., the stereoscopic display (312). The gaze rays may be determined from estimated gaze directions for each eye provided as part of the gaze direction estimation by the eye tracking component (304). Such an intersection calculation is well known as the calculation is essentially determining where a line, e.g., a gaze ray, intersects a plane, e.g., the stereoscopic display (312). An example of line/plane intersection calculation may be found at http://en.wikipedia.org/wiki/Line-plane_intersection. The difference in the horizontal pixel positions of the intersections of the two gaze rays with the stereoscopic display is the on-screen parallax. That is, the on-screen parallax is the difference in horizontal pixel coordinates where the gaze rays intersect with the display. For example, if the left gaze ray intersects the display at position x_{L}=100, and the right gaze ray intersects at position x_{R}=12, then the on-screen parallax is p=x_{R}−x_{L}=20 pixels.

Referring again to FIG. 3, the display driver component (310) initially sets the horizontal shift to be the difference between the on-screen parallax p and the representative disparity value d, p−d. Then, the display driver component (310) incrementally adjusts the horizontal shift over a period of time until the horizontal shift is the negative of the representative disparity value, i.e., −d. This gradual adjustment of the horizontal shift slowly changes the disparity where the observer's gaze is directed as indicated by the gaze direction estimation from the eye tracking component (304) from the on-screen parallax value to zero disparity. The size of the increments and the period of time are implementation dependent. In some embodiments of the invention, a feedback loop may be used to check whether or not the observer's gaze has adapted to the current horizontal shift before making another incremental adjustment.

In one or more embodiments of the invention, the display driver component (310) collects 3D convergence data, i.e., convergence depths, for an observer over a period of time, and uses this data to determine a 3D comfort zone, i.e., a convergence comfort range, for that user. The 3D comfort zone is then used by the display driver component (310) to manipulate the horizontal shift in the observer's future viewing sessions such that the observer is not shown images at convergence depths outside the observer's comfort zone.

More specifically, as a stereo video sequence is shown to the observer on the stereoscopic display (312), the display driver component (310) estimates 3D convergence points of the observer's eyes for a period of time based on the estimated gaze directions of each of the eyes provided by the eye tracking component (304) and stores the 3D convergence points. Under ideal conditions, a 3D convergence point will be 3D point in space where the gaze rays from the eyes intersect in space. When the gaze rays do not meet precisely at a point, the 3D point where the distance between the gaze rays achieves a minimum value is used as the convergence point. As illustrated in FIG. 4, the 3D convergence point may be behind or in front of the display surface.

The period of time may be any suitable period of time, such as, for example, the entire stereo video sequence, an empirically determined period of time, an observer-selected period of time, a combination thereof, or the like. Further, the stereo video sequence may be any suitable video sequence, such as for example, an observer-selected stereo video sequence, a training stereo video sequence, the first stereo video sequence viewed by the observer, etc. After the period of time, the display controller component (310) analyzes the stored 3D convergence points to determine the minimum and maximum convergence depths of the observer during the period of time. Theses minimum and maximum convergence depths are considered to bound the observer's 3D comfort zone. This 3D comfort zone may then be stored by the display controller component (310), e.g., in an observer profile, and used to customize the observer's future viewing sessions.

In the observer's future viewing sessions, gaze direction estimation and disparity estimation are performed to determine representative disparity values in ROIs. If a representative disparity value falls outside the observer's 3D comfort zone, i.e., is smaller than the minimum convergence depth or larger than the maximum convergence depth, the horizontal shift is adjusted so that the disparity where the observer's gaze is directed falls within the observer's 3D comfort zone. Note that disparity is inversely proportional to convergence depth. For example, if the ROI has a representative disparity value of −10 pixels and the observer has a 3D comfort zone of [−6, 12] pixels, the observer will likely not be able to adapt to that ROI comfortably. Accordingly, the horizontal shift would be set to at least −4 to ensure the observer has a good chance of convergence.

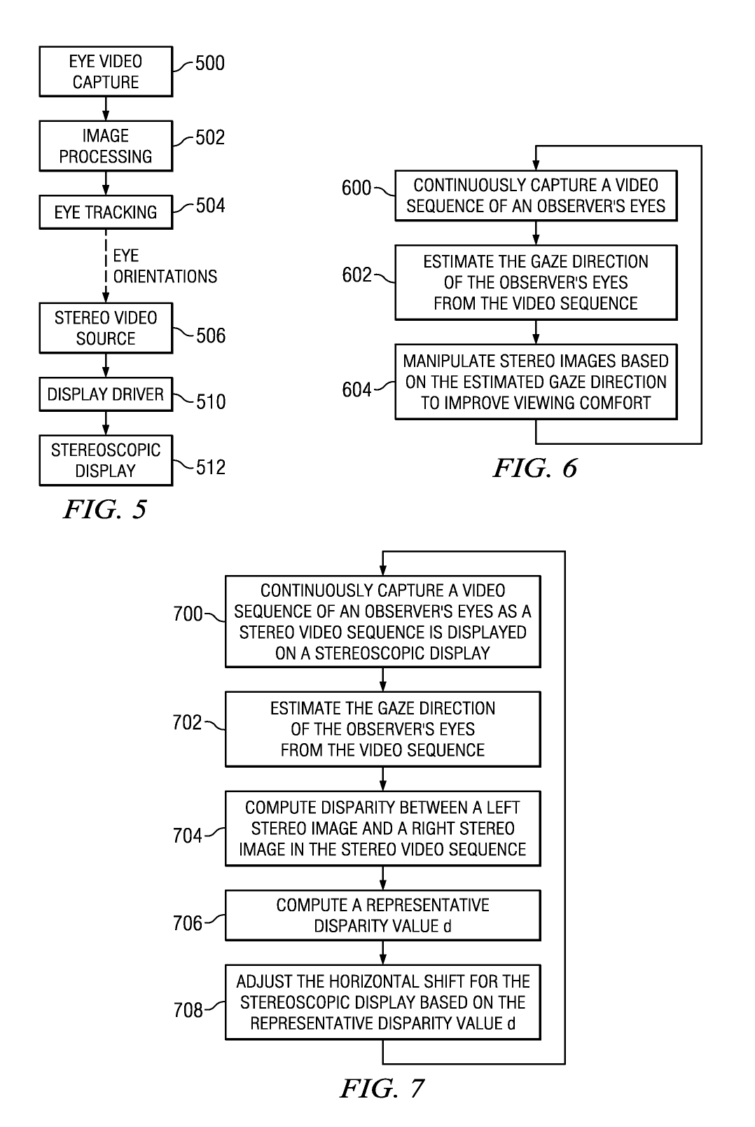

FIG. 5 is a block diagram of a stereoscopic display system in accordance with one or more embodiments of the invention. The stereoscopic display system includes an eye video capture component (500), an image processing component (502), an eye tracking component (504), a stereo video source (506), a display driver component (510), and a stereoscopic display (512). The display driver component (510) includes functionality to control the operation of the stereoscopic display (512), including receiving stereo video from the stereo video source (506) and causing the stereoscopic display (512) to display the stereo video.

The eye video capture component (504) is positioned to capture optical images of an observer's eyes. The eye video capture component (504) may be, for example, a CMOS sensor, a CCD sensor, etc., that converts optical images to analog signals. These analog signals may then be converted to digital signals and provided to the image processing component (502).

The image processing component (502) divides the incoming digital signal into frames of pixels and processes each frame to enhance the image in the frame. The processing performed may include one or more image enhancement techniques. For example, the image processing component (502) may perform one or more of black clamping, fault pixel correction, color filter array (CFA) interpolation, gamma correction, white balancing, color space conversion, edge enhancement, detection of the quality of the lens focus for auto focusing, and detection of average scene brightness for auto exposure adjustment. The processed frames are provided to the eye tracking component (504). In some embodiments of the invention, the eye video capture component (500) and the image processing component (502) may be a digital video camera.

The eye tracking component (504) includes functionality to analyze the frames of the video sequence in real-time, i.e., as a stereo video is displayed on the stereoscopic display (512), to detect the observer's eyes, track their movement, and estimate the gaze direction, also referred to as point of regard (PoR) or point of gaze (POG). Any suitable techniques with sufficient accuracy may be used to implement the eye detection, tracking, and gaze direction estimation. Some suitable techniques are described in D. W. Hansen and Q. Ji, “In the Eye of the Beholder: A Survey of Models for Eyes and Gaze”, IEEE Transactions on Pattern Analysis and Machine Intelligence, Vol. 32, No. 3, 2010. The gaze direction estimation, i.e., the orientation of the observer's eyes relative to the stereoscopic display (512), is provided to the stereo video source (506). Note that the eye orientations map naturally from biological eyes to stereo camera position.

The stereo video source (506) provides a stereo video sequence for display on the stereoscopic display (512). The stereo video source (506) may be a system that includes virtual flexible stereo cameras, e.g., a graphics system that generates a stereo video sequence in real-time, or a real flexible stereo camera system that captures a stereo video sequence in real-time. The stereo video source (506) includes functionality to receive gaze direction estimations from the eye tracking component (504) and adjust the orientations of the stereo video cameras, whether virtual or real, to match the orientations of the observer's eyes.

The components of the stereoscopic display systems of FIGS. 2, 3, and 5 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Further, software, e.g., software instructions for all or part of eye tracking, disparity estimation, and display control, may be stored in memory (not specifically shown) in the stereoscopic display and executed by one or more processors. The software instructions may be initially stored in a computer-readable medium such as a compact disc (CD), a diskette, a tape, a file, memory, or any other computer readable storage device and loaded and stored on stereoscopic display system. In some cases, the software instructions may also be sold in a computer program product, which includes the computer-readable medium and packaging materials for the computer-readable medium. In some cases, the software instructions may be distributed to the stereoscopic display system via removable computer readable media (e.g., floppy disk, optical disk, flash memory, USB key), via a transmission path from computer readable media on another computer system (e.g., a server), etc.

FIG. 6 shows a flow diagram of a method for improving stereo video viewing comfort in accordance with one or more embodiments of the invention. A video sequence of the eyes of an observer is continuously captured as the observer is viewing a stereo video sequence on a stereoscopic display (600). The video sequence may be captured by one or more cameras focused on the observer's eyes. The stereo video sequence may be a pre-recorded stereo video sequence or a stereo video sequence generated in real time by virtual or real stereo cameras. For example, the stereo video sequence may be generated in real-time by a computer graphics system (such as in a 3D computer game) using virtual fixed or flexible stereo cameras. A flexible stereo camera system allows camera position to be modified in real-time.

The gaze direction of the observer's eyes is estimated from the video sequence in real-time (602). The gaze direction estimation may be accomplished by a video processing algorithm that detects the observer's eyes in real-time, tracks their movement, and estimates the gaze direction. As is known by one of ordinary skill in the art, algorithms for eye detection, tracking, and gaze direction estimation are active research topics in the computer vision community. Any suitable algorithms now known or future developed with sufficient accuracy may be used to implement the eye detection, tracking, and gaze estimation. A recent survey of some suitable algorithms can be found in D. W. Hansen and Q. Ji, “In the Eye of the Beholder: A Survey of Models for Eyes and Gaze”, IEEE Transactions on Pattern Analysis and Machine Intelligence, Vol. 32, No. 3, 2010.

The stereo images of a stereo video sequence being viewed by the observer are then adjusted based on the estimated gaze direction to improve the viewing comfort of the observer (604). The stereo images may be adjusted, for example, by automatically adjusting the stereo separation (horizontal shift) between left and right images based on a reference disparity value determined based on the estimated gaze direction, or based on the reference disparity value and an on-screen parallax determined based on the estimated gaze direction. In some embodiments of the invention, the stereo images may be adjusted by automatically changing the orientations of stereo cameras (virtual or real) being used to generate the stereo video sequence to match the orientations of the observer's eyes. In such embodiments, the estimated gaze direction may be the orientations of the observer's eyes. Methods for adjusting the stereo images based on the estimated gaze direction are described below in reference to FIG. 7-10.

FIG. 7 shows a flow diagram of a method for improving stereo video viewing comfort in accordance with one or more embodiments of the invention. Steps 700 and 702 are the same as steps 600 and 602 of FIG. 6. Once the gaze direction of the observer's eyes is estimated (702), the disparity between a left stereo image and a corresponding right stereo in the stereo video sequence is computed (704). Any suitable technique for disparity estimation may be used, such as, for example, one of the techniques described in D. Scharstein and R. Szeliski. “A Taxonomy and Evaluation of Dense Two-Frame Stereo Correspondence Algorithms”, International Journal of Computer Vision, 47(1/2/3):7-42, 2002.In some embodiments of the invention, the disparity between all pixels in the left image and corresponding pixels in the right image is estimated, and the result is a disparity image with a disparity value for each pixel pair.

In other embodiments of the invention, the disparity estimation is performed for pixels in a region of interest (ROI) in the left and right images, and the result is a disparity ROI with a disparity value for each pixel pair in the ROI. The region of interest (ROI) may be defined as a region of pixels in the two images corresponding to the estimated gaze direction. That is, the estimated gaze direction indicates an area on the stereoscopic display where the observer's gaze is directed and may be used to determine a corresponding area of pixels in the two images. This area of pixels may be used as the ROI or a larger number of pixels surrounding the area of pixels may be used.

A representative disparity value d is then computed (706). In embodiments of the invention in which a disparity image is generated, the representative disparity value is determined from an ROI in the disparity image. The ROI may be defined as a region of pixels in the disparity image corresponding to the estimated gaze direction. That is, the estimated gaze direction indicates an area on the stereoscopic display where the observer's gaze is directed and may be used to determine a corresponding area of pixels in the two images. This area of pixels may be used as the ROI or a larger number of pixels surrounding the area of pixels may be used. In embodiments of the invention in which a disparity ROI is generated, the representative disparity value is determined from the disparity ROI. Any suitable technique may be used to determine the representative disparity value, such as, for example, computing an average disparity value or a median disparity value in the ROI.

The representative disparity value d is then used to adjust the horizontal shift (stereo separation) for the stereoscopic display (708). The horizontal shift is adjusted such that there is no disparity where the observer's gaze is directed as indicated by the gaze direction estimation. In some embodiments of the invention, a horizontal shift parameter for the stereoscopic display is set to −d. Such a parameter is common in stereoscopic display systems. In the prior art, the observer manually adjusts this parameter to tune the viewing experience. With this method, and others described herein, the adjustment of this parameter is done automatically based on the observer's gaze.

Note that this method is performed continuously as the stereo video sequence is being displayed. That is, the disparity of the area where the observer's gaze is focused is continuously tracked. This area may display objects that move in the scene (up/down, or left/right within the stereoscopic display, or closer/farther away). Other objects may also enter the scene and occlude the area. Further, the focus of the observer's gaze may move to another area. The method does not need to track these objects or identify them or even specifically detect that the observer's gaze may have moved. Rather, it operates based on a representative disparity value in the region of interest (ROI) at which the observer is gazing at any point in time. If the representative disparity value changes, the horizontal shift may be automatically adjusted in response to that change.

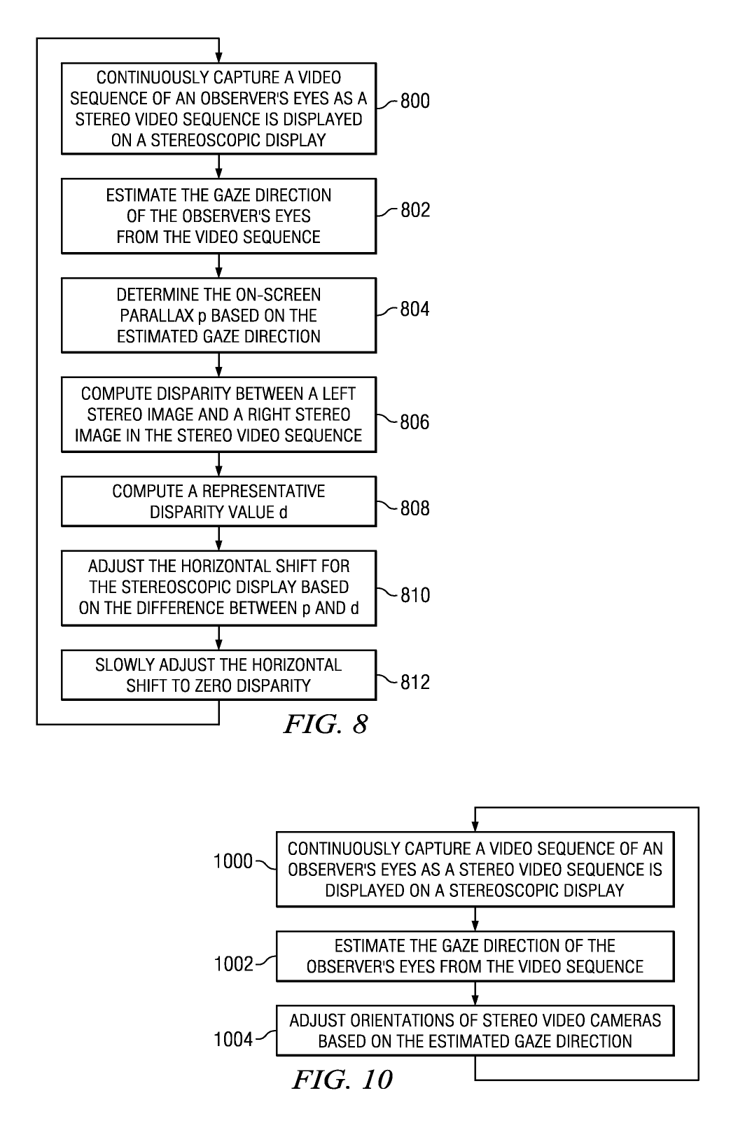

FIG. 8 shows a flow diagram of a method for improving stereo video viewing comfort in accordance with one or more embodiments of the invention. Steps 800 and 802 are the same as steps 600 and 602 of FIG. 6. Once the gaze direction is estimated (802), the on-screen parallax p is then determined based on the estimated gaze direction (804). The on-screen parallax may be computed as previously described in reference to FIGS. 3 and 4.

The disparity between a left stereo image and a corresponding right stereo in the stereo video sequence is also computed (806) as well as representative disparity value d (808). Steps 806 and 808 are the same as steps 704 and 706 of FIG. 7.

The difference between the on-screen parallax p and the representative disparity value d (p−d) is then used to adjust the horizontal shift (stereo separation) for the stereoscopic display (810) and the horizontal shift is then slowly adjusted over a period of time until zero disparity is reached (812). In some embodiments of the invention, a horizontal shift parameter for the stereoscopic display is set to p−d and incrementally changed until the value of the horizontal shift parameter is −d. This gradual adjustment of the horizontal shift slowly changes the disparity where the observer's gaze is directed as indicated by the gaze direction estimation from the on-screen parallax value to zero disparity. The incremental size of the adjustments and the period of time are implementation dependent. In some embodiments of the invention, a feedback loop may be used to check whether or not the observer's gaze has adapted to the current horizontal shift before making another incremental adjustment.

Note that this method is performed continuously as the stereo video sequence is being displayed. That is, the disparity of the area where the observer's gaze is focused is continuously tracked as well as the on-screen parallax. The area of focus may display objects that move in the scene (up/down, or left/right within the stereoscopic display, or closer/farther away). Other objects may also enter the scene and occlude the area. Further, the focus of the observer's gaze may move to another area or the on-screen parallax may change if the observer's gaze changes. The method does not need to track these objects or identify them or even specifically detect that the observer's gaze may have moved. Rather, it operates based on a representative disparity value in the region of interest (ROI) at which the observer is gazing at any point in time and on an on-screen parallax determined based on the observer's gaze. If the representative disparity value changes or the on-screen parallax changes, the horizontal shift may be automatically adjusted in response to those changes.

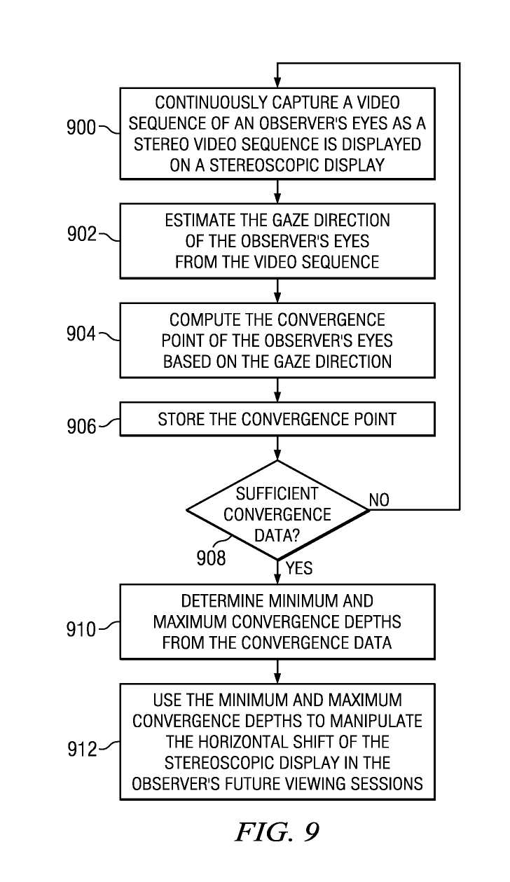

FIG. 9 shows a flow diagram of a method for improving stereo video viewing comfort in accordance with one or more embodiments of the invention. Steps 900 and 902 are the same as steps 600 and 602 of FIG. 6. In addition to the examples previously listed, the stereo video sequence may also be a training video sequence. Once the gaze direction is estimated (902), the 3D convergence point of the observer's eyes is computed based on the estimated gaze direction (904) and stored (906). More specifically, the 3D position in space where the observer's eyes are converging is estimated from the estimated gaze direction of each eye. This 3D convergence point may be behind or in front of the projection surface. Under ideal conditions, a 3D convergence point will be 3D point in space where the gaze rays from the eyes intersect in space. When the gaze rays do not meet precisely at a point, the 3D point where the distance between the gaze rays achieves a minimum value is used as the convergence point. As illustrated in FIG. 4, the 3D convergence point may be behind or in front of the display surface.

The steps 902-906 are repeated until sufficient convergence data for the observer is collected (908). In some embodiments of the invention, the collection of convergence data is conducted for a period of time. The period of time may be any suitable period of time, such as, for example, the entire stereo video sequence, an empirically determined period of time, an observer-selected period of time, a combination thereof, or the like. In some embodiments of the invention, the collection of convergence data is conducted until some number of convergence points has been stored. The number of convergence points may be any suitable number that will result in a representative range of convergence points for the observer and may be implementation dependent.

When sufficient convergence data is collected (908), the stored 3D convergence points are analyzed to determine the minimum and maximum convergence depths of the observer (910). Theses minimum and maximum convergence depths are the observer's 3D comfort zone. This 3D comfort zone may then be stored, e.g., in an observer profile, and used to customize the observer's future viewing sessions (912). That is, the minimum and maximum convergence depths are used in the future viewing sessions to automatically adjust the horizontal shift of the stereoscopic display (912).

In the observer's future viewing sessions, gaze direction estimation and disparity estimation are performed to determine representative disparity values in ROIs. If a representative disparity value falls outside the observer's 3D comfort zone, i.e., is smaller than the minimum convergence depth or larger than the maximum convergence depth, the horizontal shift is adjusted so that the disparity where the observer's gaze is directed galls within the observer's 3D comfort zone. Note that disparity is inversely proportional to convergence depth. For example, if the ROI has a representative disparity value of −10 pixels and the observer has a 3D comfort zone of [−6, 12] pixels, the observer will likely not be able to adapt to that ROI comfortably. Accordingly, the horizontal shift would be set to at least −4 to ensure the observer has a good chance of convergence.

FIG. 10 shows a flow diagram of a method for improving stereo video viewing comfort in accordance with one or more embodiments of the invention. This method assumes that the stereo video sequence is generated in real-time by virtual or real flexible stereo video cameras. Steps 1000 and 1002 are the same as steps 600 and 602 of FIG. 6. The estimated gaze direction provides the orientations of the observer's eyes. Once the gaze direction is estimated (1002), the orientations of the stereo video cameras are adjusted based on the estimated gaze direction (1004). That is, the orientations of the stereo video cameras, whether virtual or real, are changed to match the orientations of the observer's eyes as per the estimated gaze direction.

Note that this method is performed continuously as the stereo video sequence is being generated and displayed. That is, the gaze direction of the observer's eyes is continuously estimated from the eye video sequence. The area of where the observer is gazing may display objects that move in the scene (up/down, or left/right within the stereoscopic display, or closer/farther away). Other objects may also enter the scene and occlude the area. Further, the observer's gaze may move to another area. The method does not need to track these objects or identify them or even specifically detect that the observer's gaze may have moved. Rather, it operates based on estimating the gaze direction. If the gaze direction changes, the orientations of the stereo video cameras are automatically adjusted in response to the change in the estimated gaze direction.

The methods described in this disclosure may be implemented in hardware, software, firmware, or any combination thereof. If completely or partially implemented in software, the software may be executed in one or more processors, such as a microprocessor, application specific integrated circuit (ASIC), field programmable gate array (FPGA), or digital signal processor (DSP). The software that executes the methods may be initially stored in a computer-readable medium and loaded and executed in the processor. In some cases, the software may also be sold in a computer program product, which includes the computer-readable medium and packaging materials for the computer-readable medium. Examples of computer-readable media include non-writable storage media such as read-only memory devices, writable storage media such as disks, memory, or a combination thereof.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of improving stereo video viewing comfort, the method comprising:
capturing a video sequence of eyes of an observer viewing a stereo video sequence on a stereoscopic display;
estimating gaze direction of the eyes from the video sequence; and
manipulating stereo images in the stereo video sequence based on the estimated gaze direction, whereby viewing comfort of the observer is improved.

2. The method of claim 1, wherein manipulating stereo images comprises:
computing disparity between a left stereo image and a right stereo image in the stereo video sequence;
computing a representative disparity value; and
adjusting horizontal shift for the stereoscopic display based on the representative disparity value.

3. The method of claim 2, wherein adjusting horizontal shift comprises setting a horizontal shift parameter to −d, wherein d is the representative disparity value.

4. The method of claim 2, wherein
computing disparity generates a disparity image; and
computing a representative disparity value comprises:
determining a region of interest in the disparity image based on the estimated gaze direction; and
computing the representative disparity value in the region of interest.

5. The method of claim 2, wherein
computing disparity comprises:
determining a region of interest in the left stereo image and the right stereo image based on the estimated gaze direction; and
computing disparity over the region of interest to generate a disparity region of interest; and
computing a representative disparity value comprises computing the representative disparity value in the disparity region of interest.

6. The method of claim 2, further comprising:
computing on-screen parallax based on the estimated gaze direction; and
adjusting horizontal shift comprises adjusting the horizontal shift based on the representative disparity value and the on-screen parallax.

7. The method of claim 6, wherein adjusting horizontal shift comprises:
changing the horizontal shift based on a difference between the on-screen parallax and the representative disparity value; and
adjusting the horizontal shift incrementally to achieve zero disparity.

8. The method of claim 7, wherein zero disparity is achieved when the horizontal shift has a value equal to −d, wherein d is the representative disparity value.

9. The method of claim 1, wherein manipulating stereo images comprises:
adjusting orientations of stereo video cameras capturing the stereo video sequence based on the estimated gaze direction.

10. A method of improving stereo video viewing comfort, the method comprising:
capturing continuously a video sequence of eyes of an observer viewing at least a portion of a first stereo video sequence on a stereoscopic display;
estimating gaze directions of the eyes from the video sequence;
computing convergence points of the eyes based on the estimated gaze directions;
analyzing the computed convergence points to determine a minimum convergence depth and a maximum convergence depth; and
using the minimum and maximum convergence depth to adjust horizontal shift of the stereoscopic display as the observer views a second stereo video sequence, whereby viewing comfort of the observer is improved.

11. A stereoscopic display system comprising:
a stereo video source configured to provide a stereo video sequence;
a stereoscopic display configured to display the stereo video sequence;
an eye video capture component configured to capture a video sequence of eyes of an observer viewing the stereo video sequence on the stereoscopic display; and
an eye tracking component configured to estimate gaze direction of the eyes from the video sequence,
wherein stereo images in the stereo video sequence are manipulated based on the estimated gaze direction, whereby viewing comfort of the observer is improved.

12. The stereoscopic display system of claim 11, wherein the stereo video source is configured to adjust orientations of stereo video cameras capturing the stereo video sequence based on the estimated gaze direction.

13. The stereoscopic display system of claim 11, further comprising:
a disparity estimation component configured to compute disparity between a left stereo image and a right stereo image in the stereo video sequence, and
wherein the eye tracking component is further configured to
compute a representative disparity value from the estimated disparity; and
adjust horizontal shift for the stereoscopic display based on the representative disparity value.

14. The stereoscopic display system of claim 13, wherein the eye tracking component is configured to adjust horizontal shift by setting a horizontal shift parameter to −d, wherein d is the representative disparity value.

15. The stereoscopic display system of claim 13,
wherein the disparity estimation component is configured to compute disparity by generating a disparity image, and
wherein the eye tracking component is configured to compute the representative disparity value by
determining a region of interest in the disparity image based on the estimated gaze direction; and
computing the representative disparity value in the region of interest.

16. The stereoscopic display system of claim 13,
wherein the disparity estimation component is configured to compute disparity by
determining a region of interest in the left stereo image and the right stereo image based on the estimated gaze direction; and
computing disparity over the region of interest to generate a disparity region of interest; and
wherein the eye tracking component is configured to compute the representative disparity value in the disparity region of interest.

17. The stereoscopic display system of claim 13, wherein the eye tracking component is further configured to
compute on-screen parallax based on the estimated gaze direction; and
adjust the horizontal shift based on the representative disparity value and the on-screen parallax.

18. The stereoscopic display system of claim 17, wherein the eye tracking component is further configured to adjust the horizontal shift by
changing the horizontal shift based on a difference between the on-screen parallax and the representative disparity value; and
adjusting the horizontal shift incrementally to achieve zero disparity.
